(19) United States
(12) Patent Application Publication
(10) Pub. No.: US 2009/0070492 A1
(43) Pub. Date: Mar. 12, 2009

(54) SYSTEM AND METHOD FOR INDICATING A PRESENCE OF A PORTABLE MEMORY MEDIUM

(76) Inventors: Marianne KODIMER, Huntintgon Beach, CA (US); Jianxin Wang, Trabuco Canyon, CA (US); Kenneth J. Stephenson, San Clemente, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/851,069

(22) Filed: Sep. 6, 2007

(51) Int. Cl. G06F 3/00

(52) U.S. Cl. 710/15

(57) ABSTRACT

The subject application is directed to a system and method for a presence of a portable memory medium. A plurality of graphical elements are first generated on an associated display, each of which correspond to a unique portable data storage medium interface. Device data is then received representing a presence of a portable data storage medium in at least one of the portable data storage medium interfaces. An indicator is then generated on the associated display corresponding to each graphical element associated with a portable data storage medium interface for which a presence of a portable data storage medium is indicated via received device data.

### BACKGROUND OF THE INVENTION

The subject application is directed generally to systems adapted to receive data from a plurality of different portable data storage devices. The application is particularly applicable to document processing devices, including kiosks, where users are unsophisticated or otherwise not familiar with transferring of data from such portable data storage devices.

Documents processing devices include copiers, printers, facsimile machines, photo-printers, data vaults, file servers, and the like. While many document processing devices allow users to send documents via a network, many applications require a user to transport electronic documents directly to the device on a memory storage medium. This is particularly true in devices that are shared in public places, such as photo kiosks, copy centers, printing kiosks, and the like.

Users of such shared data processing devices may transport data, such as electronic documents, in many different formats, such as CD, DVD, flash memory device, or any of a myriad of proprietary storage formats, such as SD, mini-SD. A generally available device ideally needs to support interfacing with many such devices to maximize its usability and availability. However, users of such devices may not be technologically sophisticated or otherwise familiar with the device. They may not be aware that a device is connected and available for transfer of data from the data storage to the document processing device.

### SUMMARY OF THE INVENTION

In accordance with one embodiment of the subject application, there is provided a system and method adapted to receive data from a plurality of different portable data storage devices.

Further, in accordance with one embodiment of the subject application, there is provided a system and method for indicating a presence of a portable memory medium that is particularly applicable to document processing devices, including kiosks, where users are unsophisticated or otherwise not familiar with transferring of data from such portable data storage devices.

Still further, in accordance with one embodiment of the subject application, there is provided a system for indicating a presence of a portable memory medium. The system comprises means adapted for generating, on an associated display, a plurality graphical elements, each graphical element corresponding to a unique portable data storage medium interface and means adapted for receiving device data representative of a presence of a portable data storage medium in at least one portable data storage medium interface. The system further comprises means adapted for generating an indicator on the display corresponding to each graphical element associated with a portable data storage medium interface for which a presence of a portable data storage medium is indicated via received device data.

In one embodiment of the subject application, the graphical elements depict a media interface on an associated data processing device. In a preferred embodiment, each graphical element includes a corresponding descriptive textual element associated therewith.

In another embodiment of the subject application, the indicator is comprised of alteration of textual elements for which presence of a portable storage medium is indicated relative to remaining textual elements. In a preferred embodiment, the alteration of textual elements is further comprised of means adapted for graying out of textual elements associated graphical elements for which no presence of a portable data storage medium is indicated.

In yet another embodiment of the subject application, a plurality of graphical elements depicts a storage medium interface adapted to receive data from a non-volatile, portable data storage medium from the set comprising: flash memory, CD, DVD, smart card, PC card, express card, IEEE 1394, and universal serial bus device and wireless data storage device.

Still further, in accordance with one embodiment of the subject application, there is provided a method for indicating a presence of a portable memory medium in accordance with the system as set forth above

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a portable memory medium indicator system according to one embodiment of the subject application;

FIG. 2 is a block diagram illustrating device hardware for use in the portable memory medium indicator system according to one embodiment of the subject application;

FIG. 3 is a functional diagram illustrating the device for use in the portable memory medium indicator system according to one embodiment of the subject application;

FIG. 4 is a block diagram illustrating controller hardware for use in the portable memory medium indicator system according to one embodiment of the subject application;

FIG. 5 is a functional diagram illustrating the controller for use in the portable memory medium indicator system according to one embodiment of the subject application;

FIG. 6 is a flowchart illustrating a method for indicating a presence of a portable memory medium according to one embodiment of the subject application;

FIG. 7 is a flowchart illustrating a method for indicating a presence of a portable memory medium according to one embodiment of the subject application;

FIG. 8 is a screen template illustrating a graphical user interface implemented in the method for indicating a presence of a portable memory medium according to one embodiment of the subject application;

FIG. 9 is a screen template illustrating a graphical user interface implemented in the method for indicating a presence of a portable memory medium according to one embodiment of the subject application; and

FIG. 10 is a screen template illustrating a graphical user interface implemented in the method for indicating a presence of a portable memory medium according to one embodiment of the subject application.

### DETAILED DESCRIPTION OF THE PREFERRED EMBODIMENT

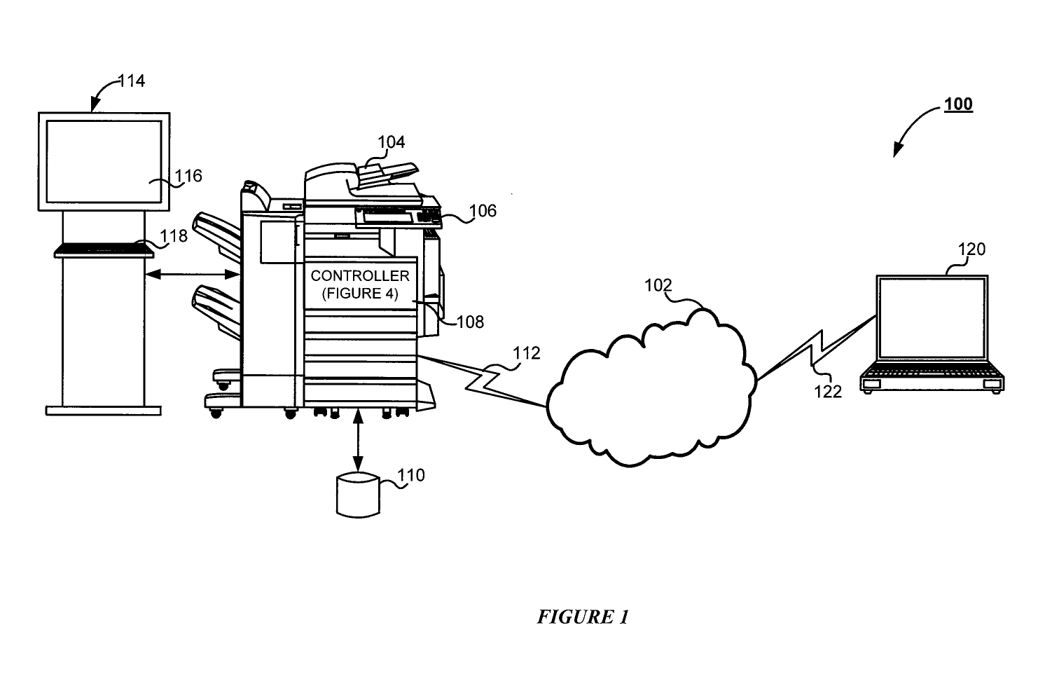

The subject application is directed to a system and method adapted to receive data from a plurality of different portable data storage devices. In particular, the subject application is directed to a system and method for indicating a presence of a portable memory medium that is particularly applicable to document processing devices, including kiosks, where users are unsophisticated or otherwise not familiar with transferring of data from such portable data storage devices. It will become apparent to those skilled in the art that the system and method described herein are suitably adapted to a plurality of varying electronic fields employing visual feedback, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a portable memory medium indicator system 100 in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

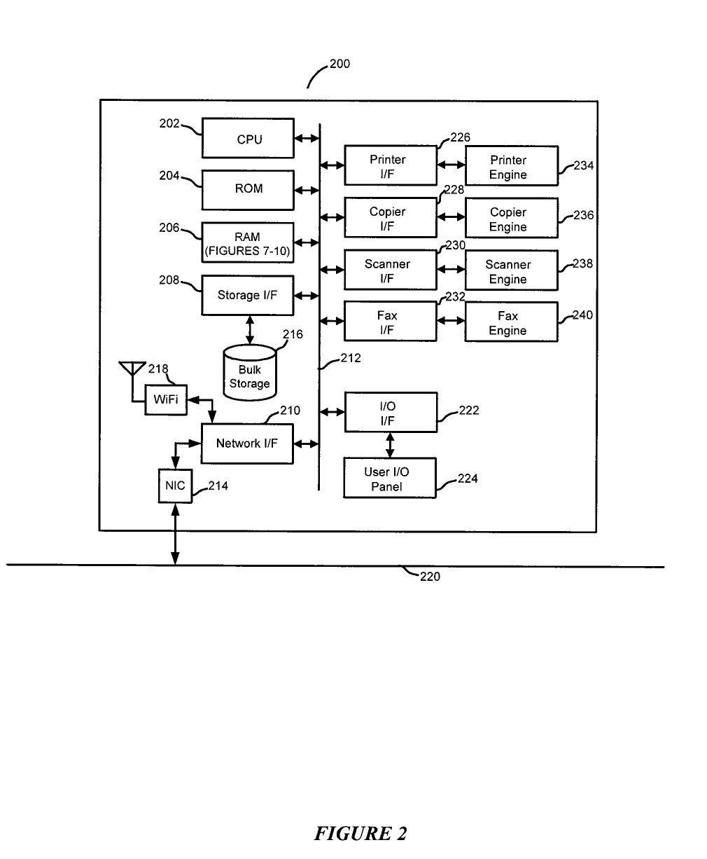

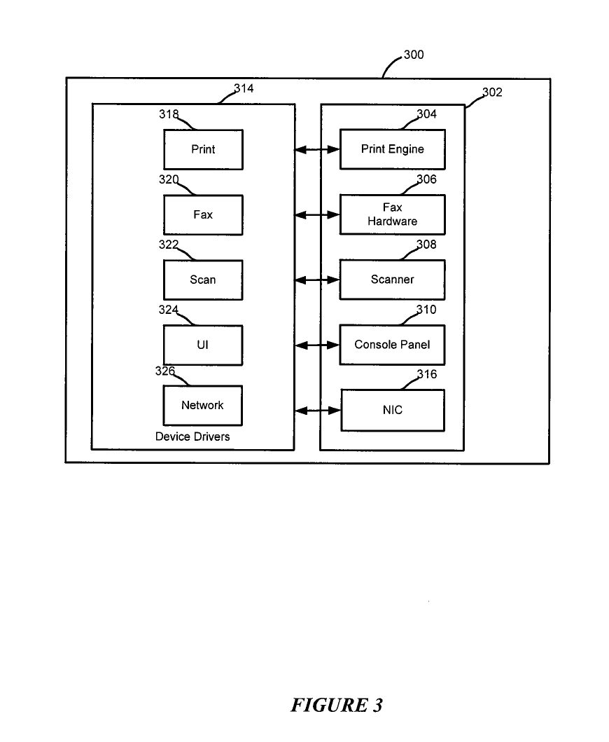

The system 100 also includes a first document processing device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like. The functioning of the document processing device 104 will better be understood in conjunction with the block diagrams illustrated in FIGS. 2 and 3, explained in greater detail below.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

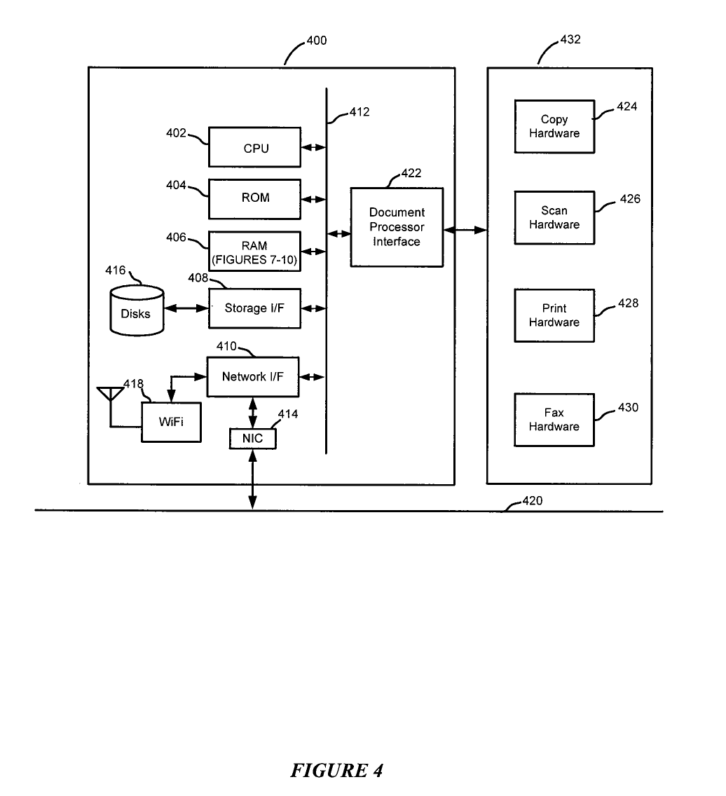

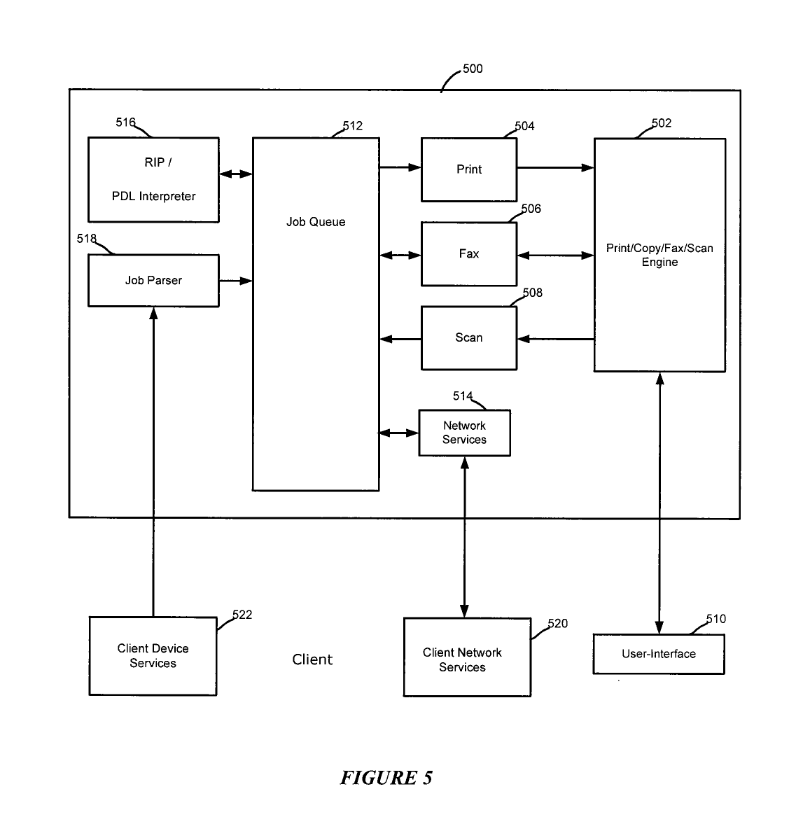

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 is capable of being performed by any general purpose computing system, known in the art, and thus the controller 108 is representative of such general computing devices and are intended as such when used hereinafter. Furthermore, the use of the controller 108 hereinafter is for the example embodiment only, and other embodiments, which will be apparent to one skilled in the art, are capable of employing the system and method for indicating the presence of a portable memory medium of the subject application. The functioning of the controller 108 will better be understood in conjunction with the block diagrams illustrated in FIGS. 4 and 5, explained in greater detail below.

Communicatively coupled to the document processing device 104 is a data storage device 110. In accordance with the preferred embodiment of the subject application, the data storage device 110 is any mass storage devices known in the art including, for example and without limitation, magnetic storage drives, a hard disk drive, optical storage devices, flash memory devices, or any suitable combination thereof. In the preferred embodiment, the data storage device 110 is suitably adapted to store document data, image data, electronic database data, or the like. It will be appreciated by those skilled in the art that while illustrated in FIG. 1 as being a separate component of the system 100, the data storage device 110 is capable of being implemented as an internal storage component of the associated document processing device 104, a component of the controller 108, or the like, such as, for example and without limitation, an internal hard disk drive, or the like. In accordance with one embodiment of the subject application, the data storage device 110 is capable of storing images, graphical elements, fonts, user content, and the like.

Illustrated in FIG. 1 is a kiosk 114, communicatively coupled to the document processing device 104, and in effect, the computer network 102. It will be appreciated by those skilled in the art that the kiosk 114 is capable of being implemented as a separate component of the document processing device 104, or as an integral component thereof. Use of the kiosk 114 in FIG. 1 is for example purposes only, and the skilled artisan will appreciate that the subject application is capable of implementation without the use of kiosk. In accordance with one embodiment of the subject application, the kiosk 114 includes a display 116 and a user input device 118. As will be understood by those skilled in the art the kiosk 114 is capable of implementing a combination user input device/display, such as a touch screen interface. According to one embodiment of the subject application, the kiosk 114 is suitably adapted to display prompts to an associated user, receive instructions from the associated user, receive payment data, receive selection data from the associated user, and the like. Preferably, the kiosk 114 is suitably adapted to receive a plurality of various types of portable storage media, such as, for example and without limitation, flash memory, CD, DVD, smart card, PC card, express card, IEEE 1394, universal serial bus devices, wireless data storage devices, and the like.

The system 100 illustrated in FIG. 1 further depicts a user device 120, in data communication with the computer network 102 via a communications link 122. It will be appreciated by those skilled in the art that the user device 120 is shown in FIG. 1 as a laptop computer for illustration purposes only. As will be understood by those skilled in the art, the user device 120 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 122 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 120 is suitably adapted to generate and transmit electronic documents, document processing instructions, user interface modifications, upgrades, updates, personalization data, or the like, to the document processing device 104, or any other similar device coupled to the computer network 102. In accordance with one embodiment of the subject application, the user device 120 includes a web browser application, suitably adapted to securely interact with the document processing device 104, or the like. The skilled artisan will appreciate that the user device 120 is also capable of implementation as an administrative device, whereupon a user associated with the device 120 is able to access, delete, view, or otherwise modify data stored on the data storage device 110 associated with the document processing device 104.

Turning now to FIG. 2, illustrated is a representative architecture of a suitable device 200, (shown in FIG. 1 as the document processing device 104), on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, (shown in FIG. 1 as the document processing device 104), for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 108 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with bus the 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which include the controller 400 of FIG. 4, (shown in FIG. 1 as the controller 108) as an intelligent subsystem associated with a document processing device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The Parser 518 functions to interpret a received electronic document file and relay it to the job queue 512 for handling in connection with the afore-described functionality and components.

In operation, a plurality of graphical elements are generated on an associated display, each of which correspond to a unique portable data storage medium interface. Device data is then received representing a presence of a portable data storage medium in at least one of the portable data storage medium interfaces. An indicator is then generated on the associated display corresponding to each graphical element associated with a portable data storage medium interface for which a presence of a portable data storage medium is indicated via received device data.

In accordance with one example embodiment of the subject application, a document processing request is received from an associated user via the user interface 106, the kiosk 114, or the like. Preferably, the document processing request corresponds to an operation to be performed on one or more electronic files stored on a portable data storage medium. As will be appreciated by those skilled in the art, such portable data storage mediums include, for example and without limitation, flash memory, CD, DVD, smart card, PC card, express card, IEEE 1394, universal serial bus device, a wireless data storage device, e.g., the user device 120, or the like. Upon receipt of the document processing request, a graphical user interface is initiated via the user interface 106 of the document processing device 104, or the display 116 of the kiosk 114 associated with the document processing device 104. In accordance with one embodiment of the subject application, the graphical user interface includes indicia adapted to direct user interactions with the document processing device 104 so as to facilitate the performance of a selected document processing operation.

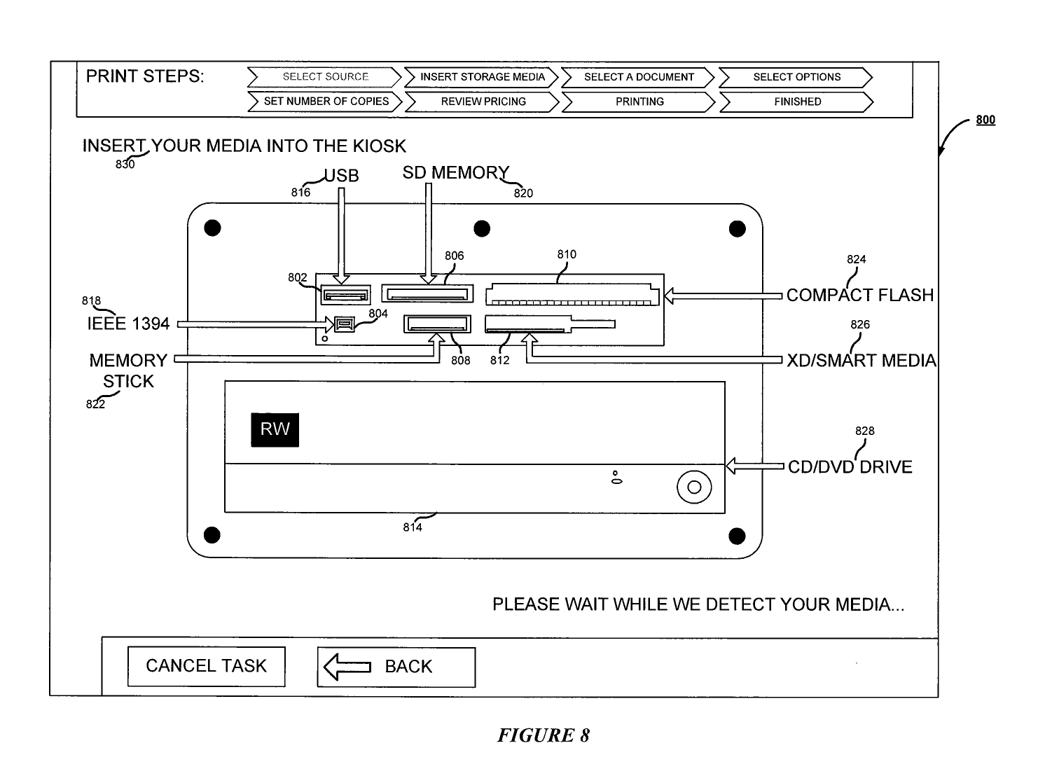

Graphical elements representing various portable data storage medium interfaces, along with corresponding textual elements, or descriptors, are then generated on the user interface 106, the display 116, or the like. In accordance with one embodiment of the subject application, a multi-card reader illustration is generated via the user interface 106 or display 116 corresponding to each type of portable storage medium, or card, supported by the associated document processing device 104 or kiosk 114. A textual element generated via the user interface 106 or display 116 suitably describe a graphical element with which it is associated. Thus, for example and without limitation, a graphical element depicting a universal serial bus port will include a textual element identifying the graphical image on the display 116 or user interface 106 as a “USB” port, an element depicting a secure digital memory medium will include a textual element identifying the graphical element as an “SD Memory” interface, and the like. Examples of the representation of the graphical and textual elements are described in greater detail below with respect to FIGS. 8-10.

The user is then prompted, via the graphical user interface, to insert a portable storage medium into the appropriate receptacle on the document processing device 104 or the kiosk 114. Upon the detection of the presence of a portable storage medium, the medium is accessed by the controller 108 or other suitable component associated with the document processing device 104 or kiosk 114 to determine whether device data corresponding to the portable storage medium has been received. That is, whether the component associated with the kiosk 114 or document processing device 104 has been able to access the portable storage medium detected. When unable to access the medium, i.e., the device data associated with the protable storage medium has not been received, the associated user is notified of the error and is prompted to insert, or reinsert, the portable storage medium.

When device data has been received, an indicator is generated on the user interface 106 or display 116 corresponding to a graphical element associated with a portable storage medium interface indicating the presence of a portable storage medium in the corresponding interface. Suitable examples of such indicators include, without limitation, highlighting of the element, augmenting the color of the element, depicting a graphical representation of the portable storage medium inserted into corresponding interface, or other suitable visual indicators, as will be appreciated by those skilled in the art. The textual elements of the graphical element corresponding to the portable storage medium interface for which a portable storage medium is present are thereafter altered to reflect the presence, such as, for example and without limitation, bolding the elements, highlighting the elements, colorizing the elements, or other suitable visual indication. Similarly, those textual elements of the graphical elements that have not storage mediums present are altered, such as for example and without limitation, by graying out the text, or the like.

The user is then prompted via the graphical user interface to proceed with the requested document processing operation. When the user has not elected to proceed, such as by selecting a suitable icon of the graphical user interface, a determination is made whether an additional medium has been detected, i.e., whether the user has inserted another portable storage medium into its corresponding interface. When such an additional medium is detected, operations return to accessing the medium to receive device data, as set forth above. When the user has elected to proceed, electronic files, such as documents, images, presentations, or the like, are retrieved from the detected portable storage medium and displayed to the user via the user interface 106 or the display 116. Via the graphical user interface displayed on the user interface 106 or the display 116, the user selects one or more files associated with the received document processing request. Thereafter, the document processing device 104 performs the selected document processing operation on the selected files retrieved from the portable data storage mediums.

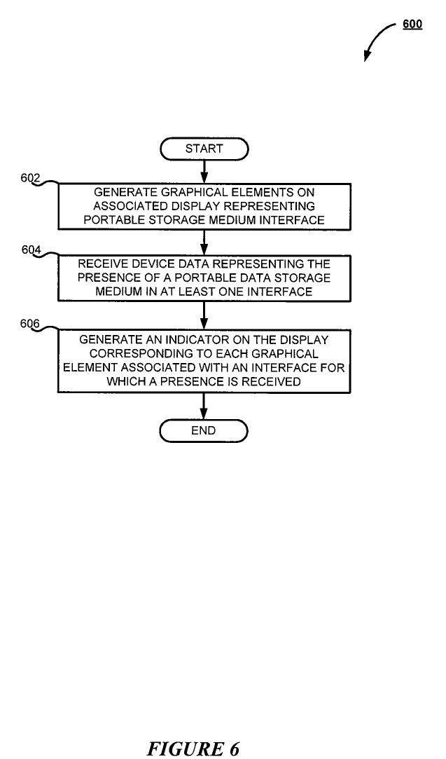

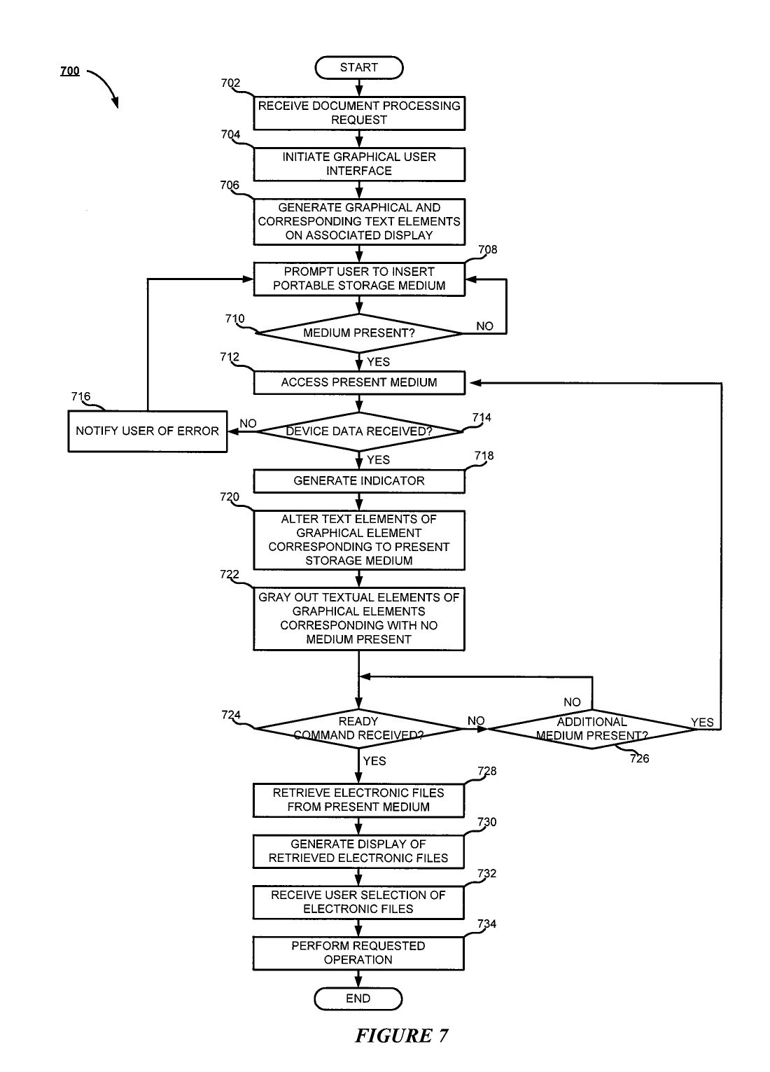

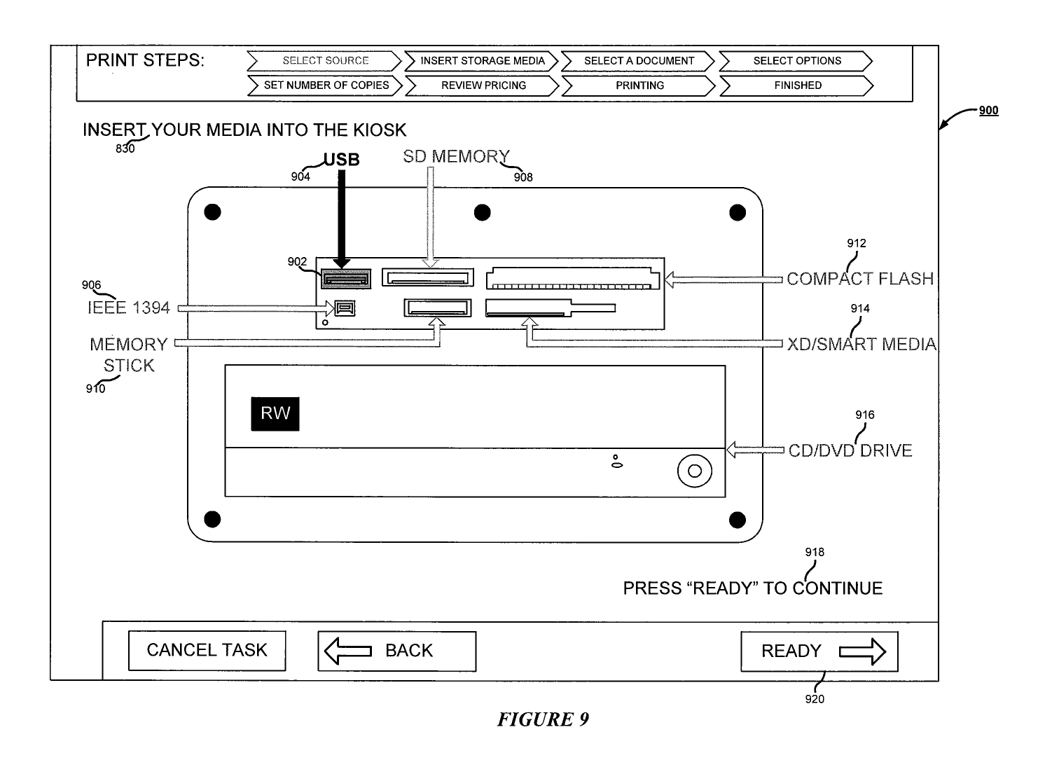

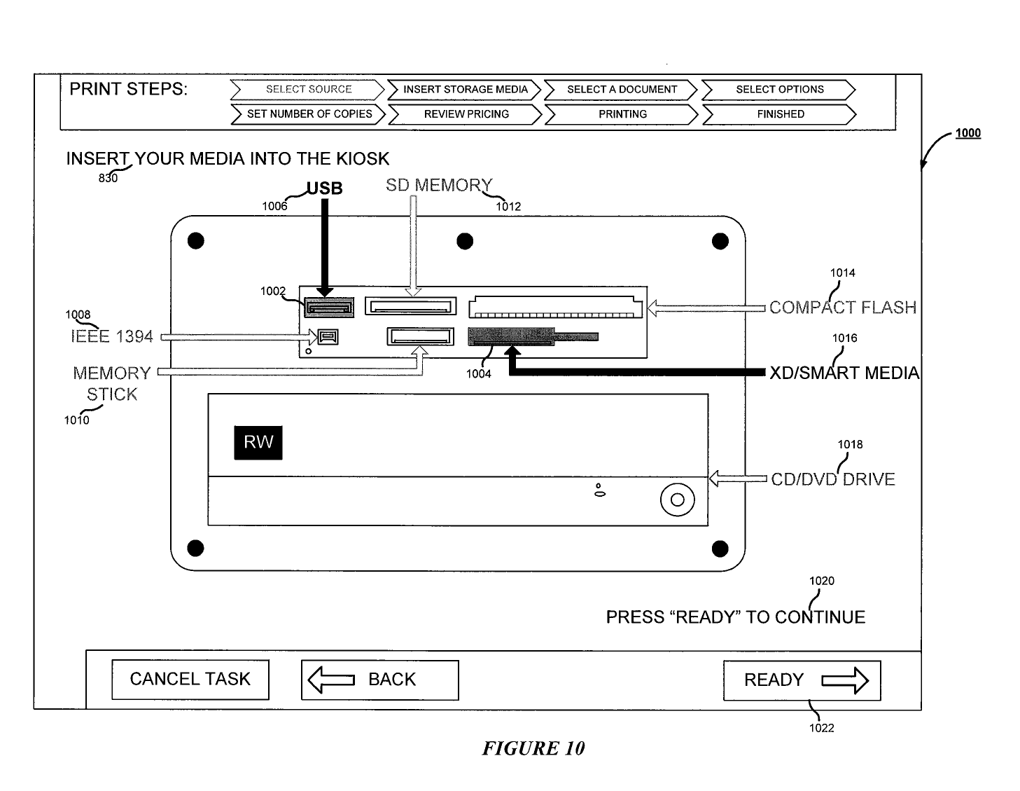

The skilled artisan will appreciate that the subject system 100 and components described above with respect to FIG. 1, FIG. 2, FIG. 3, FIG. 4, and FIG. 5 will be better understood in conjunction with the methodologies described hereinafter with respect to FIG. 6 and FIG. 7 and the graphical user interface screenshots of FIG. 8, FIG. 9, and FIG. 10. Turning now to FIG. 6, there is shown a flowchart 600 illustrating a method for indicating a presence of a portable memory medium in accordance with one embodiment of the subject application. Beginning at step 602, a plurality of graphical elements, each of which correspond to a unique portable data storage medium interface, are generated on an associated display. In accordance with one embodiment of the subject application, the graphical elements are generated on the user interface 106 of the document processing device 104, the display 116 of the kiosk 114, or the like. As will be appreciated by those skilled in the art, such portable data storage mediums include, for example and without limitation, flash memory, CD, DVD, smart card, PC card, express card, IEEE 1394, universal serial bus device, a wireless data storage device, e.g., the user device 120, or the like. At step 604, device data is received representing the presence of a portable data storage medium in at least one of the portable data storage medium interfaces. An indicator is then generated on the associated display, at step 606, corresponding to each graphical element associated with a portable data storage medium interface for which a presence of a portable data storage medium is indicated in accordance with the received device data.

Referring now to FIG. 7, there is shown a flowchart 700 illustrating a method for indicating a presence of a portable memory medium in accordance with one embodiment of the subject application. At step 702, whereupon a document processing request, corresponding to an operation to be performed on one or more electronic files stored on a portable data storage medium, is received by the document processing device 104. A graphical user interface is then initiated at step 704 to facilitate the display of user prompts and the receipt of user instructions with respect to the requested document processing operation. It will be understood by those skilled in the art that the graphical user interface is advantageously generated via the user interface 106 of the document processing device 104, the display 116 of the kiosk 114, or the like. Suitable examples of such a graphical user interface are illustrated in FIGS. 8-10, discussed herein with respect to the methodology of FIG. 7.

At step 706, graphical and corresponding text elements are generated via the user interface 106 or the display 116 illustrating various portable storage medium interfaces and their respective text descriptions. Referring now to FIG. 8, there is shown a screen template illustrating a graphical user interface 800 implemented in the method for indicating a presence of a portable memory medium in accordance with one embodiment of the subject application. As depicted in FIG. 8, the interface 800 includes a plurality of portable data storage medium interfaces 802-814. That is, the interface 800 includes graphical representations of a universal serial bus port 802, an IEEE 1394 port 804, a secure digital memory card interface 806, a memory stick interface 808, a compact flash interface 810, an xD/smart media interface 812, and a CD/DVD drive 814. Corresponding to each of the portable data storage medium interfaces 802-814 are respective text elements 816-828, which provide a description of the corresponding portable data storage medium interface. Thus, as shown in FIG. 8, the universal serial bus port 802 includes “USB” text element 816, the IEEE 1394 port 804 includes “IEEE 1394” text element 818, the secure digital memory card interface 806 includes “SD Memory” text element 820, the memory stick interface 808 includes “memory stick” text element 822, the compact flash interface 810 includes “compact flash” text element 824, the xD/smart media interface 812 includes “xD/smart media” text element 826, and the CD/DVD drive 814 includes “CD/DVD drive” text element 828. It will be appreciated by those skilled in the art that the graphical user interface 800 illustrated in FIG. 8 is for example purposes only, and the various portable data storage medium interfaces 802-814 depicted thereon are not intended to limit the subject application solely to those interfaces 802-814. The skilled artisan will appreciate that the subject application is capable of implementation using any type of portable data storage medium, as are known in the art.

Returning to FIG. 7, following the generation of the graphical elements 802-814 and the textual elements 816-828 at step 706, flow proceeds to step 708, whereupon the user is prompted to insert a portable storage medium. FIG. 8 illustrates such a prompt 830, as will be appreciated by those skilled in the art. In accordance with one embodiment of the subject application, such portable data storage mediums include, for example and without limitation, flash memory, CD, DVD, smart card, PC card, express card, IEEE 1394, universal serial bus device, a wireless data storage device, e.g., the user device 120, or the like. At step 710, a determination is made whether a portable storage medium is present, i.e., whether or not the user has inserted a portable storage medium into the associated interface 802-814. When no medium is detected, flow returns to step 708, whereupon the prompt 830 to insert a portable storage medium remains displayed on the graphical user interface 800. When a medium is detected, flow progresses to step 712, whereupon the document processing device 104 or kiosk 114 attempts to access the inserted medium. A determination is then made at step 714 whether device data has been received indicating the accessibility and presence of the inserted portable data storage medium. When the portable data storage medium is not accessible, i.e., device data has not been received, the user is notified of the error at step 716 and flow returns to prompting the user to insert a portable storage medium at step 708. It will be appreciated by those skilled in the art that the portable storage medium inserted but not accessible is capable of resulting from a damaged medium, corrupted data, faulty connection, software failure, or the like. In such an event, as will be understood by those skilled in the art, removal and reinsertion of the medium is undertaken to correct the error.

When the device data is received at step 714, flow progresses to step 718, whereupon an indicator is generated on the graphical user interface 800 corresponding to a graphical element associated with the portable data storage medium indicated via the device data. Attention is now directed to FIG. 9, wherein there is shown a template graphical user interface 900 illustrating the display of the graphical user interface upon detection and access of a portable storage medium. As depicted in FIG. 9, a universal serial bus device has been detected by the document processing device 104 or the kiosk 114. Thus, in accordance with step 718, an indicator is generated on the graphical user interface 900 corresponding to the universal serial bus port 902 illustrating to the user that a portable data storage medium is present at the universal serial bus port 902. The skilled artisan will appreciate that suitable indicators include, for example and without limitation, shading, highlighting, bolding, a graphical representation of the medium, or the like.

Flow then proceeds to step 720, whereupon the text elements 904 associated with the graphical element 902 representing the portable storage medium interface that has detected the presence of a portable storage medium are altered. In accordance with one embodiment of the subject application, the text element 904 is bolded, colored, highlighted, shaded, or other wise distinguished so as to indicate to the user which portable storage medium is being accessed. FIG. 9 illustrates the bolding and shading of the text element 904 to indicate the presence of a universal serial bus device. At step 722, the textual elements 906-916 associated with portable storage medium interfaces without a detected portable storage medium are grayed out or otherwise altered to indicate the lack of a portable storage medium at the interface. FIG. 9 depicts these textual elements as grayed out, however the skilled artisan will appreciate that other methods or implementations are capable of being employed to distinguish these elements 906-916 from the “USB” text element 904.

Operations then proceed to step 724, whereupon a determination is made whether a ready or continue command has been received from the associated user. For example, a determination is made whether the user has selected the “ready” icon 920 of the graphical user interface 900 in response to the prompt 918 indicating a desire to proceed to completion of the requested document processing operation. When a ready or continue command has not been received, flow proceeds to step 726, whereupon a determination is made whether an additional portable storage medium has been detected. When no additional portable storage mediums are detected, flow returns to step 724, awaiting user instructions to continue the document processing operation.

When an additional portable storage medium is present, as determined at step 726, flow returns to step 712, whereupon the present portable storage medium is accessed. Reference is now made to FIG. 10, which depicts a graphical user interface 1000 indicating the presence of two portable storage mediums, as will be explained hereinafter. Once the device data for the additional portable storage medium has been received, flow progresses to step 718, whereupon an indicator is generated on the graphical user interface 1000 indicating the presence of the additional portable storage medium. As shown in FIG. 10, the universal serial bus port 1002 and the xD/smart media interface 1004 have been modified to indicate the presence of portable storage medium in both interfaces 1002 and 1004. At step 720, the text elements associated with the additional present portable storage medium, e.g., the xD/smart media element 1016, is altered, as is the first universal serial bus element 1006, to indicate the presence of portable storage mediums in both interfaces 1004 and 1002, respectively. The remaining text elements 1008-1014 and 1018, are grayed out, or otherwise modified at step 722 to reflect that these interfaces do not have corresponding portable storage mediums present.

Flow then proceeds to step 724, whereupon a determination is made whether the associated user has selected the “Ready” icon 1022 in accordance with the user prompt 1020. When the user has not elected to continue, e.g., select the “Ready” icon 1022, flow proceeds to step 726 and operations continue in accordance with the method set forth above. It will be understood by those skilled in the art that in accordance with one embodiment of the subject application, each portable data storage medium inserted into its associated portable data storage medium interface results in modifications to the graphical element and textual elements associated therewith. Thus, as the skilled artisan will appreciate, the graphical user interface, shown in FIGS. 8-10, is dynamically and continuously modified to provide visual feedback to the associated user upon insertion by the user of a portable data storage medium into an associated portable storage medium interface.

Returning to FIG. 7, when the user has selected the “Ready” icon 1022, flow proceeds to step 728, whereupon the electronic files stored on the present portable data storage mediums are retrieved. At step 730, a display is generated, via the user interface 106 or the display 116, illustrating the retrieved electronic files to the associated user. User selection of one or more electronic files for processing in accordance with the received document processing request is then received from the user at step 732 via the user interface 106, the display 116, the input device 118, or the like. The document processing device 104 thereafter performs the requested document processing operation on the selected electronic files at step 734.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A portable memory medium indicator system comprising:
means adapted for generating, on an associated display, a plurality graphical elements, each graphical element corresponding to a unique portable data storage medium interface;
means adapted for receiving device data representative of a presence of a portable data storage medium in at least one portable data storage medium interface; and
means adapted for generating an indicator on the display corresponding to each graphical element associated with a portable data storage medium interface for which a presence of a portable data storage medium is indicated via received device data.

2. The system of claim 1 wherein the graphical elements depict a media interface on an associated data processing device.

3. The system of claim 2 wherein each graphical element includes a corresponding descriptive textual element associated therewith.

4. The system of claim 1 wherein the indicator is comprised of alteration of textual elements for which presence of a portable storage medium is indicated relative to remaining textual elements.

5. The system of claim 4 wherein alteration of textual elements is further comprised of means adapted for graying out of textual elements associated graphical elements for which no presence of a portable data storage medium is indicated.

6. The system of claim 1 wherein a plurality of graphical elements depicts a storage medium interface adapted to receive data from a non-volatile, portable data storage medium from the set comprising: flash memory, CD, DVD, smart card, PC card, express card, IEEE 1394, and universal serial bus device and wireless data storage device.

7. A method for indicating a presence of a portable memory medium comprising the steps of:
generating, on an associated display, a plurality graphical elements, each graphical element corresponding to a unique portable data storage medium interface;
receiving device data representative of a presence of a portable data storage medium in at least one portable data storage medium interface; and
generating an indicator on the display corresponding to each graphical element associated with a portable data storage medium interface for which a presence of a portable data storage medium is indicated via received device data.

8. The method of claim 7 wherein the graphical elements depict a media interface on an associated data processing device.

9. The method of claim 8 wherein each graphical element includes a corresponding descriptive textual element associated therewith.

10. The method of claim 7 further comprising the step of altering textual elements for which presence of a portable storage medium is indicated relative to remaining textual elements.

11. The method of claim 10 wherein the step of altering textual elements is further comprises the step of graying out of textual elements associated graphical elements for which no presence of a portable data storage medium is indicated.

12. The method of claim 7 wherein a plurality of graphical elements depicts a storage medium interface adapted to receive data from a non-volatile, portable data storage medium from the set comprising: flash memory, CD, DVD, smart card, PC card, express card, IEEE 1394, and universal serial bus device and wireless data storage device.

13. A computer-implemented method for indicating a presence of a portable memory medium comprising the steps of:
generating, on an associated display, a plurality graphical elements, each graphical element corresponding to a unique portable data storage medium interface;
receiving device data representative of a presence of a portable data storage medium in at least one portable data storage medium interface; and
generating an indicator on the display corresponding to each graphical element associated with a portable data storage medium interface for which a presence of a portable data storage medium is indicated via received device data.

14. The computer-implemented method of claim 13 wherein the graphical elements depict a media interface on an associated data processing device.

15. The computer-implemented method of claim 14 wherein each graphical element includes a corresponding descriptive textual element associated therewith.

16. The computer-implemented method of claim 13 further comprising the step of altering textual elements for which presence of a portable storage medium is indicated relative to remaining textual elements.

17. The computer-implemented method of claim 16 wherein the step of altering textual elements is further comprises the step of graying out of textual elements associated graphical elements for which no presence of a portable data storage medium is indicated.

18. The computer-implemented method of claim 13 wherein a plurality of graphical elements depicts a storage medium interface adapted to receive data from a non-volatile, portable data storage medium from the set comprising: flash memory, CD, DVD, smart card, PC card, express card, IEEE 1394, and universal serial bus device and wireless data storage device.
